(19) United States
(12) Patent Application Publication
(10) Pub. No.: US 2016/0201408 A1
(43) Pub. Date: Jul. 14, 2016

(54) PIPE LOADER SYSTEM AND METHOD

(71) Applicant: TOT HOLDINGS INC., Calgary (CA)

(72) Inventors: Michael LITTLE, Calgary (CA); John Gunnar PERSON, Calgary (CA); David Ray Joseph REESOR, Calgary (CA); Jared Michael BOTTOMS, Calgary (CA)

(21) Appl. No.: 14/912,361

(22) PCT Filed: Aug. 15, 2014
(86) PCT No.: PCT/CA2014/050778

§ 371 Date: Feb. 16, 2016

Related U.S. Application Data
(60) Provisional application No. 61/866,863, filed on Aug. 16, 2013.

(51) Int. Cl. E21B 19/14; B25J 15/06; B66C 23/58; B66C 1/02; B66C 13/48; B66C 23/18

(52) U.S. Cl. CPC E21B 19/14; B66C 13/48; B66C 23/18; B66C 23/585; B66C 1/0262; B66C 1/0287; B25J 15/0616; Y10S 901/40

(57) ABSTRACT

A system and method for operating a pipe loader for various applications in the drilling industry are provided. The pipe loader operates with a programmable and self-calibrating control system that allows the pipe loader to be programmed and/or to mimic previous operator-performed routes to automatically load one or more pipes from at least a first location and unload the one or more pipes at at least a second location. The pipe loader has a robotic arm with a vacuum head for engaging one or more pipes with suction. The movement of the robotic arm, along with the vacuum head, may be selectively controlled an operator or by the control system.

### CROSS REFERENCE TO RELATED APPLICATIONS

This application is a 371 U.S. national stage application of International Application No. PCT/CA2014/050778, entitled, “PIPE LOADER SYSTEM AND METHOD,” and filed on Aug. 15, 2014, which claims priority from U.S. provisional patent application No. 61/866,863, filed Aug. 16, 2013, the entire contents of which are incorporated herein by reference as if set forth in full.

### FIELD OF THE INVENTION

The present invention relates to a system and method for operating a pipe loader (“PL”) for various applications in the drilling industry, for example in rig applications, including slant rigs and service rigs.

### BACKGROUND OF THE INVENTION

Most service rigs use a large catwalk system to move pipe to and from the angled v-door up to the rig floor. A typical catwalk weighs 6200-6500 lbs and is 45-55 ft long. When deployed and loaded with pipe, these units take up a large amount of room on the drilling lease. The weight of a conventional catwalk makes repositioning difficult, and often requires a heavy-duty picker. In general, it costs approximately $15,000 to $20,000 per month for renting the catwalk and associated picker costs.

Many conventional mobile rigs, such as slant rigs and conventional vertical rigs, use a winch system to drag pipe up the mast while a worker on the “monkey board” (i.e. platform) guides pipe on to the drill string. This process is time consuming and dangerous for the operator on the monkey board. The worker is placed in the direct path of moving components (e.g. pipes, winch line) and is also exposed should a blow-out or other catastrophic event occur.

### SUMMARY OF THE INVENTION

In accordance with a broad aspect of the present invention, there is provided a method for automating the pickup and drop-off of a pipe from a first location to a second location, respectively, using a robotic arm having actuators and an end effector, the robotic arm being controlled by and in communication with a processor, and the method being carried out by the processor, the method comprising: receiving a user input command to start a point programming process; detecting a selection of a first position of the end effector; recording the position of the actuators for the first position; detecting a selection of a second position of the end effector; and recording the position of the actuators for the second position.

In accordance with another broad aspect of the present invention, there is provided a pipe loader for loading and/or unloading one or more pipes, the pipe loader comprising: a base; an arm having a first end connected to the base and a second end; a rotor stator joint pivotably connected to the second end of the arm; an end effector releasably and pivotably connectable to the rotor stator joint via a lower wrist joint, the rotor stator joint allowing the end effector to rotate about an axis and the lower wrist joint allowing the end effector to passively or actively tilt relative to a horizon plane; a power unit positioned on the base for supplying power to the arm; and a control system for controlling movement of the arm and the end effector.

In accordance with yet another broad aspect of the present invention, there is provided a robotic arm for loading and unloading a pipe at a service rig, a slant rig, a conventional drilling rig, an off-shore drilling rig, or a pipe storage facility, and being connectable to a power source, a processor, and an end effector, the arm comprising: a boom having a first end and a second end; a stick having a first end and a second end, the first end being pivotably connected to the second end of the boom; an upper wrist pivotably connected to the second end of the stick, the upper wrist having a central axis; a rotor stator joint connected to the upper wrist, the rotor stator joint being rotatable about the central axis of the upper wrist; a end effector mount pivotally connected to the rotor stator joint by a lower wrist joint, thereby allowing the end effector mount to tilt relative to a horizontal plane at an angle between 0 and about 90 degrees, and the end effector mount is releasably couple-able to the end effector.

In accordance with another board aspect of the present invention, there is provided a pipe loader system comprising at least two robotic arms wherein there is a hand off zone that is reachable by the end effectors of any two of the at least two robotic arms.

Further and other aspects of the invention will become apparent to one skilled in the art when considering the following detailed description of the preferred embodiments provided herein.

### BRIEF DESCRIPTION OF THE DRAWINGS

Drawings are included for the purpose of illustrating certain aspects of the invention. Such drawings and the description thereof are intended to facilitate understanding and should not be considered limiting of the invention. Drawings are included, in which:

FIGS. 1a and 1b are side views of a sample pipe loader for use with the present invention, in accordance to one embodiment. FIG. 1a shows the pipe loader with its vacuum head in a substantially horizontal position. FIG. 1b shows the pipe loader with its vacuum head in a tilted position;

FIGS. 1c and 1d are top and bottom views, respectively, of the pipe loader shown in FIG. 1a;

FIG. 1e is a perspective view of the pipe loader shown in FIG. 1b. FIGS. 1a to 1e are collectively referred to as FIG. 1;

FIG. 2 is an exploded view of the pipe loader shown in FIG. 1e;

FIGS. 3a and 3b are top and side views, respectively, of the pipe loader in a retracted position, according to one embodiment of the present invention (collectively referred to herein as FIG. 3);

FIGS. 4a and 4b are top and side views, respectively, showing sample reach areas of a pipe loader (collectively referred to herein as FIG. 4);

FIGS. 5a and 5b are top elevation views each showing a sample position of a pipe loader relative to a rig and pipe racks (collectively referred to herein as FIG. 5);

FIG. 6 is a process flow chart of programmable logic controllers for use with a pipe loader in accordance with an embodiment of the present invention;

FIG. 7 is a process flow chart of for point programming of the programmable logic controllers in accordance with an embodiment of the present invention; and

FIG. 8 is a detailed perspective view of a portion of the pipe loader arm, in between the end effector and the stick.

### DETAILED DESCRIPTION

The description that follows and the embodiments described therein are provided by way of illustration of an example, or examples, of particular embodiments of the principles of various aspects of the present invention. These examples are provided for the purposes of explanation, and not of limitation, of those principles and of the invention in its various aspects. In the description, similar parts are marked throughout the specification and the drawings with the same respective reference numerals. The drawings are not necessarily to scale and in some instances proportions may have been exaggerated in order more clearly to depict certain features.

The PL aims to replace the conventional pipe catwalk or other loading devices, to decrease the time required to load and unload pipe (sometimes also referred to as pipe section). Locations for pipe loading and unloading include, for example, a service rig, slant rig, conventional drilling rig, off-shore drilling rig, and pipe storage facility. The PL decreases the overall footprint of the equipment on-site. In one embodiment, the PL is towable by truck, which allows the PL to be positioned in desirable locations (e.g. within the working range of the arm of the PL), and used to assist in moving one or more sections of pipe, which includes for example service pipes, drill pipes, tubing, jointed tubing, rods, and other types of tubulars, to and from the service rig. Further applications may include moving other equipment through custom crates attachments, end effectors and/or other attachments. The PL may be deployable for conventional yard loading and pipe staging for other pipe handling applications, such as pipe storage, transportation, or transfer.

The PL is operated in conjunction with a programmable and self-calibrating system that allows the PL to automatically load one or more pipes from a first location and unload the one or more pipes at a second location. In a further embodiment, there may be more loading and/or unloading locations in addition to the first and second locations.

For example, the PL may be used to load and unload pipes between the pipe rack and the v-door of a conventional drilling or service rig or the mast of a slant rig. The PL uses automated robotic articulation to move one or more pipes from racks into the required position where the pipe can be hoisted by the rig and tied in.

The application of the PL for a service rig may include one or more of: (i) picking up pipe from pipe rack and/or tub; (ii) moving pipe to service rig V-door; (iii) placing pipe on the V-door for service rig use; (iv) picking up used pipe from V-door and move same to the pipe rack; (v) moving pipe in the vicinity of the service rig; and (vi) moving pipe from pipe rack to another specified location (e.g. near the service rig but not necessarily the V-door of the rig itself).

For a slant rig or conventional drilling rig that does not have integrated pipe loaders, the use of the PL may decrease both set-up and production time and improve worker safety. The PL can be used to move equipment and replacement parts from the ground to the rig floor. The arm and vacuum system, which are described in greater detail hereinbelow, can be used to move equipment around the pad area, specifically from the pad to the rig floor using custom crates.

For an off-shore drilling rig, the PL may be hard fastened to the rig structure to decrease production time, allow for safe operation in high-winds, minimize pipe damage, and improve operational safety. For example, the PL may take pipe from behind samson posts and deliver it to the mouse hole or hole centre and vice versa. The PL may move pipe from a storage location to a staging area at different positions and/or elevations and inclinations.

For some applications multiple arms may be used. Separate arms may be trailer or skid mounted or hard fastened to a rig structure. The arms may be at different positions, heights and inclinations including vertical or inverted mounts. The arms may have similar or different sizes, range of motion and degrees of freedom. In one example, a trailer mounted PL is used together with a PL mounted on a derrick mast, the latter's arm being smaller and having fewer degrees of freedom, configured particularly for moving pipe in the immediate vicinity of the derrick. For applications with multiple arms, there may be a pipe hand off zone that is reachable by two or more of the arms (i.e. within the reach zone of each arm).

The PL may provide the following advantages to the above-listed applications:
Safety: The PL can be operated from a distance under automation. This removes workers from the rig area, and may reduce the risks associated with operator fatigue.
Efficiency: The PL aims to increase efficiency by reducing the time required for the loading process. A traditional catwalk is a large, slow device, while the PL arm is designed to operate such that the rig is almost never waiting. By using a vacuum head and simultaneous articulation of multiple actuators, which are described in more detail hereinbelow, the PL may promote smoother operation which may reduce the cycle time.
Precision: The system may place pipe in a greater range of locations in a more precise and repeatable manner, with minimal input, than the conventional catwalk.
Pad Footprint: The small mobile platform of the PL, which is described in more detail hereinbelow, allows the loader to be positioned and located on the drilling pad. The footprint and operating zone of the PL may use less than half the ground space of a conventional catwalk. This may allow for both quick repositioning of all equipment and potentially tighter distribution of well heads on a lease, which may improve utilization of available pad space.
Minimal pipe damage: The use of vacuum in the PL helps eliminate the use of mechanical grippers or slings that typically apply point load forces that can damage or deform pipe. The vacuum system assists in distributing force across a large contact area, which may accommodate side slip forces without pinching the pipe material like a mechanical gripper.

In one embodiment, the system for operating the PL is a combination of manual controls and automated programmable logic controllers (PLC). The operator of the PL may use both radio remote and/or fixed controls depending on the required task.

The PL is preferably designed to operate in North American drilling environments. In a further embodiment, the PL is configured to operate in temperatures ranging from about −20° C. and 30° C. In still a further embodiment, the PL may be configured to operate in temperatures ranging from about −50° C. to about 60° C. The PL can be designed to operate in various climates combinations. In a preferred embodiment, the PL is designed to withstand rough travel conditions.

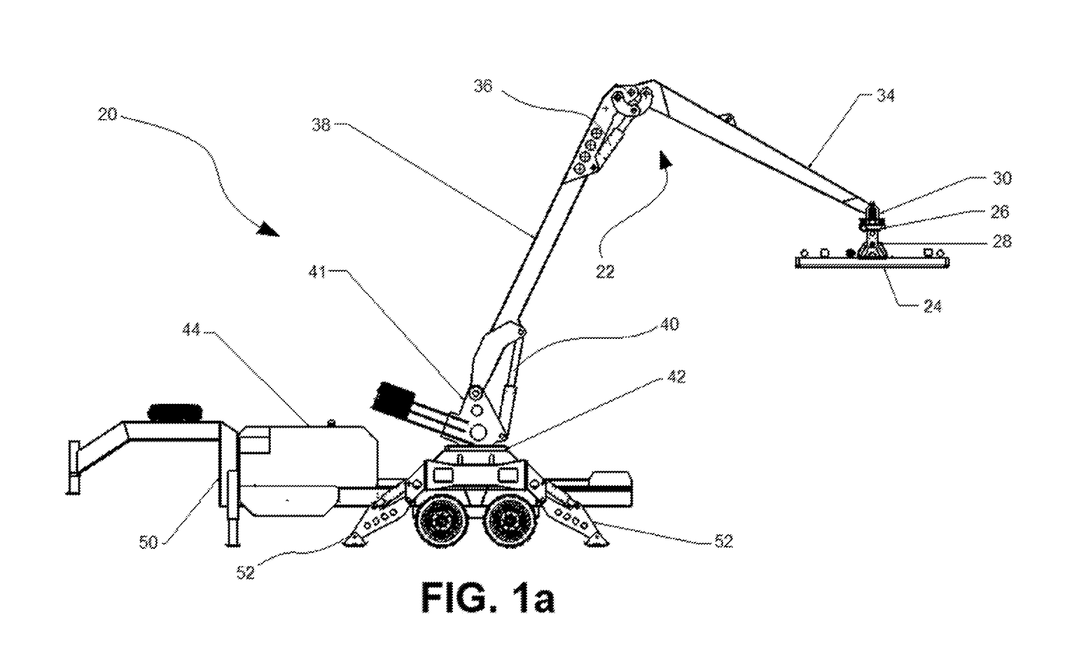

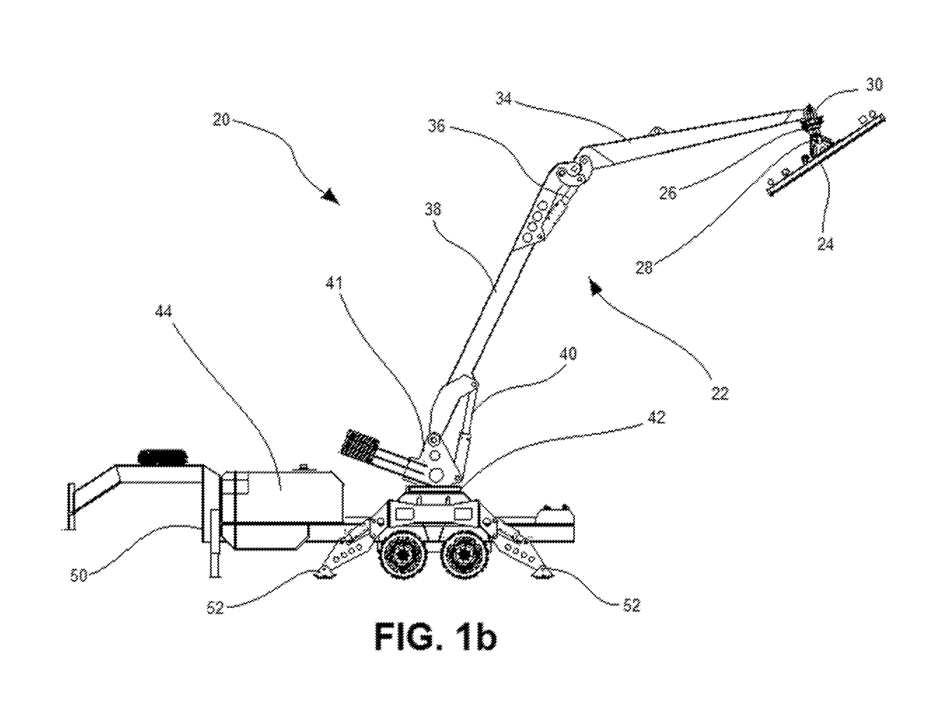

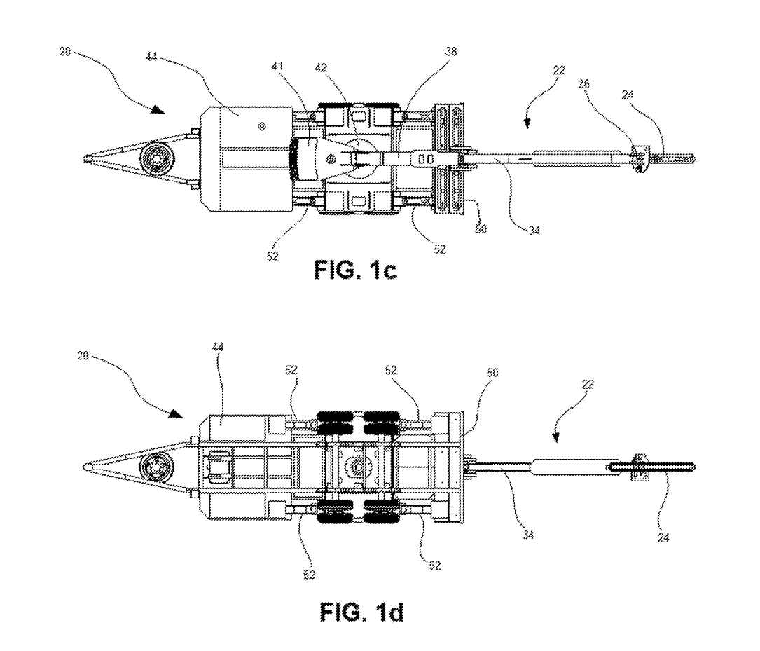

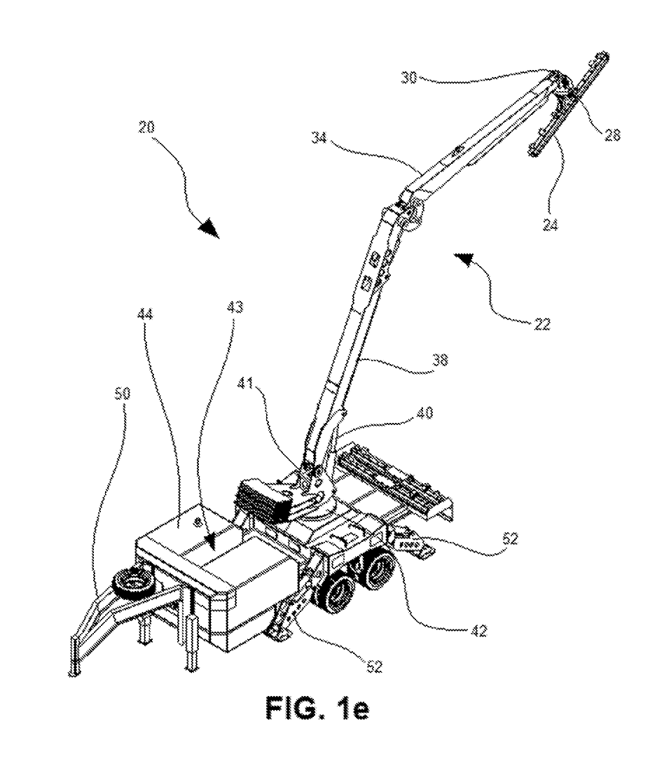

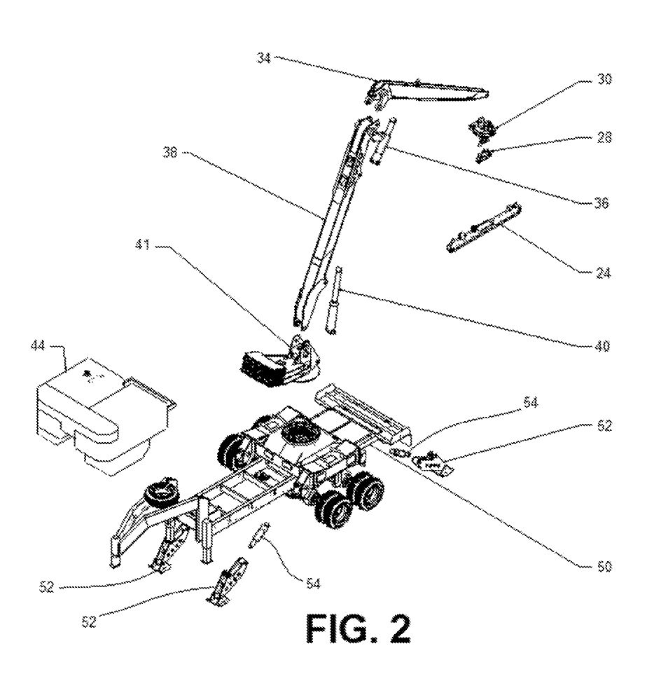

An embodiment of the PL is illustrated in FIGS. 1, 2 and 3. The PL 20 comprises a three-link, hydraulically actuated arm 22 for use in manipulating and moving one or more pipe sections (not shown) from a first location to a second location. In the illustrated embodiment, the arm 22 includes a wrist joint (which includes a lower wrist 28, upper wrist 30, and rotor stator joint 26), stick 34 (also sometimes referred to as “forearm”), elbow joint 36, boom 38, shoulder joint 40, turret 41, and slew drive 42. The wrist joint is releasably connectable to a vacuum head 24.

Various vacuum heads and systems may be used in the PL, including for example the Vacuworx™ vacuum head described in U.S. Pat. No. 8,375,711, the content of which is incorporated herein. Other vacuum heads may be used, such as a vacuum head without a motor in the head stage. For such a vacuum head, the vacuum is provided by vacuum lines from a vacuum pump in the base structure of the PL. A vacuum head is one of the many end effectors that may be used in the PL. The arm may attach to other types of end effector including for example, mechanical grips, magnets, welding guns, etc.

The end effector may optionally include more than one vacuum head to increase stability of a pipe loaded thereon. The inclusion of an additional vacuum head or heads may also ease the pick-up of small pipes by distributing the load on the pipe more evenly, since the arm exerts a small downward force on the pipe in order to engage the vacuum head with the pipe. When a small pipe is being picked up at a location where it is not fully supported (e.g. at the V-door), the downward force can deflect it, thereby preventing full engagement of the vacuum head with the pipe. The inclusion of two or more vacuum heads may help evenly distribute the load on the pipe, which may assist in prevention deflection of the pipe.

In one embodiment, the arm is configured to move pipes with diameters ranging from about 2⅜″ to about 8½″. Of course, the arm may be designed and configured to move pipes of other sizes. The multiple links, degrees of freedom and actionable joints in the arm help to optimize the motion path of the arm in order to accommodate constrained spaces, equipment obstacles, worker safety zones, and other pad constraints.

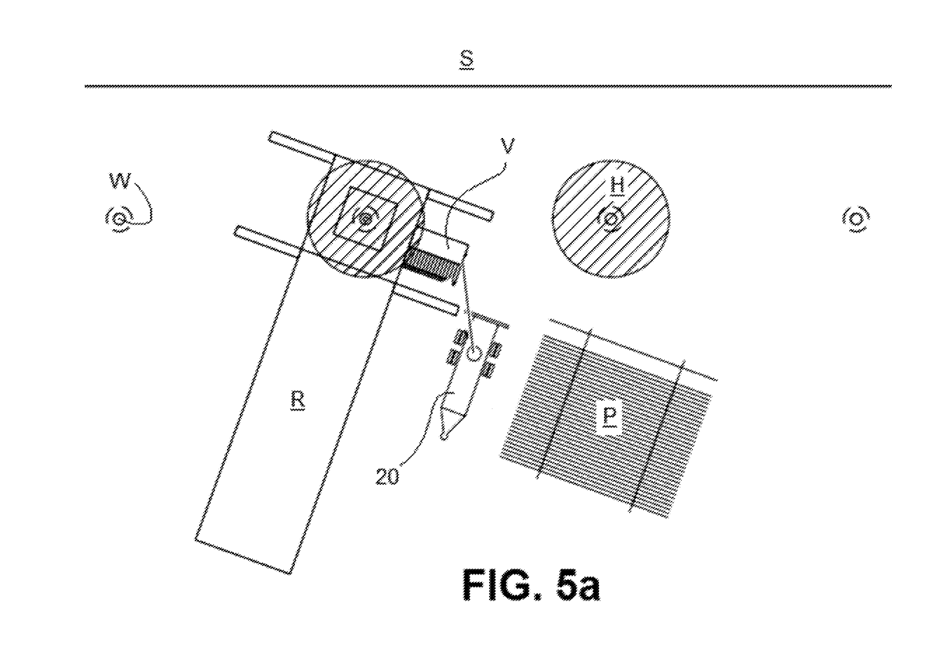

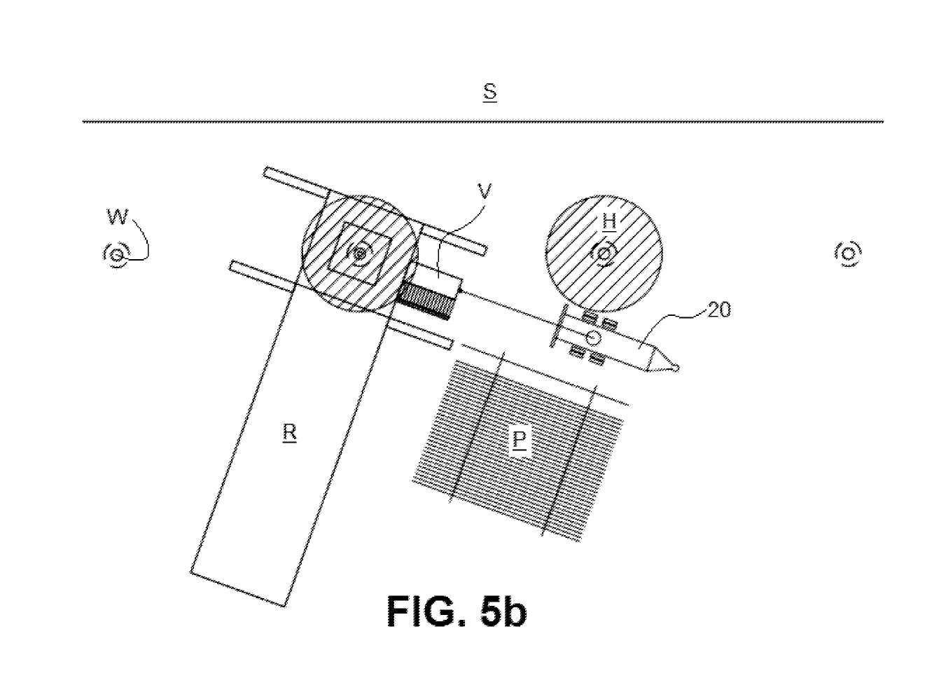

FIG. 5 shows sample locations of the PL relative to a rig R and pipe racks P. In FIG. 5, a rig R is situated adjacent to a well W. The rig R has a V-door V near one end, which is positioned near a structure S. Pipe racks P is situated near one lengthwise side of rig R, where the V-door is positioned. The rig is in between the well W and the pipe racks P. There is a hazardous zone H near the pipe racks P and the V-door end of the rig R. In one sample embodiment, as shown in FIG. 5a, the PL 20 is placed between the rig and the pipe racks. In another sample embodiment, as shown in FIG. 5b, the PL 20 is placed between the hazardous zone H and the pipe racks P such that one end of the PL directly faces the V-door. Or course, the PL may be placed in other locations relative to the rig and the pipe racks.

Referring FIGS. 1 to 3, the PL comprises a power unit 44 for driving and controlling the PL. In one embodiment, the power unit 44 includes a hydraulic power unit for supplying power to the arm 22, a vacuum pump for supplying suction to the vacuum head 24 via the arm, and a control system for controlling the movement of the arm and/or vacuum head. The control system also controls the supply of suction from the vacuum to the vacuum head. The control system includes PLC.

The power unit 44 may include for example a motor. In a sample embodiment, the power unit comprises a diesel power unit with about 25 to about 50 HP for running the hydraulics, pumps, and/or electronics of the PL. In another embodiment, the power for one or more of the hydraulics, pumps, and electronics of the PL may be supplied by other power sources, such as for example, solar power unit, electrical power unit, etc. whether supported on or external to the mobile base.

In addition, the PL may have mounted thereon hydraulic reservoirs, vacuum reservoirs, toolboxes, etc. The PL may further include a GPS asset tracking device.

In a preferred embodiment, the PL is towable by a towing vehicle to a position in close proximity to the pipe rack and rig. However, it is not necessary that the PL be towable. The PL may be truck or skid mounted.

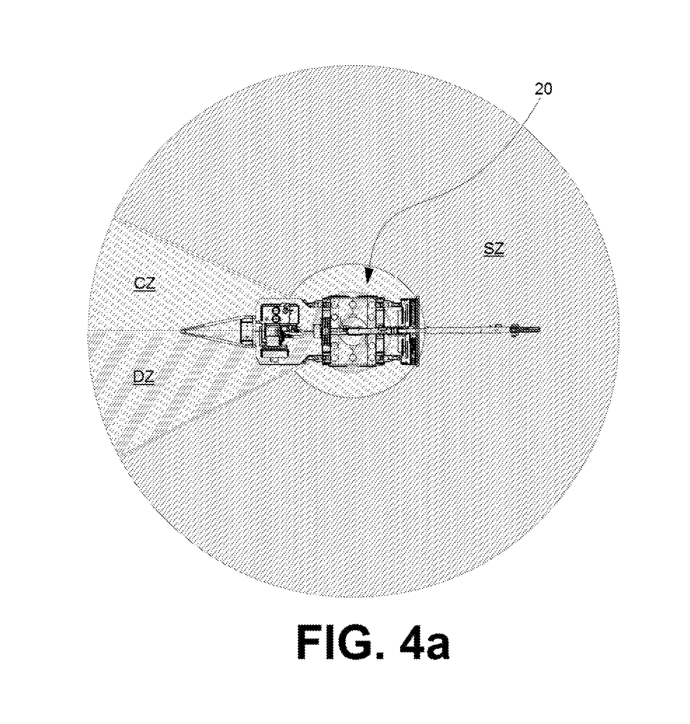

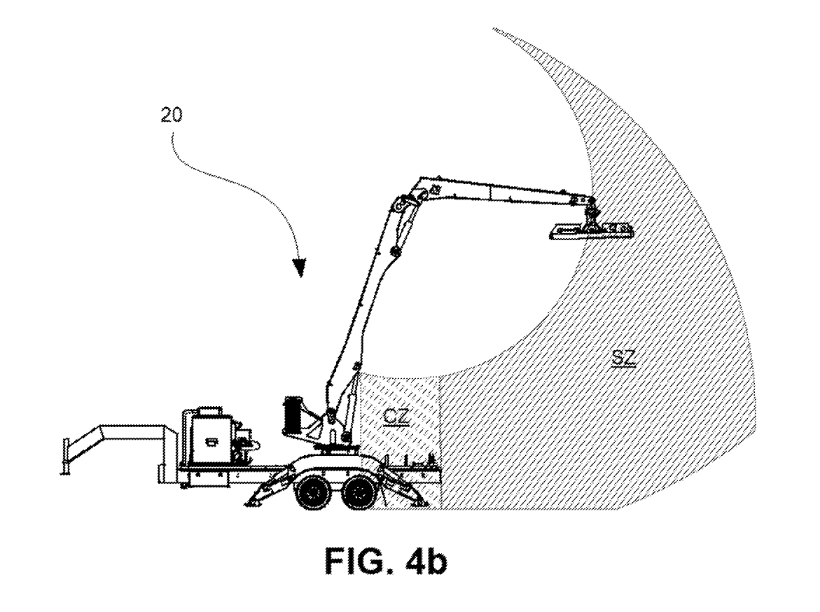

In one embodiment, the PL is set up onsite in a fixed position. The location of the PL is preferably selected to allow optimal positioning at the end points of travel within reach zones SZ and CZ (as shown in FIG. 4).

In an embodiment where the PL is towable, the PL has a mobile base 50 with wheels, bogie, gooseneck, jack, and/or tow hitch, outrigger hydraulic actuators 54, and deployable levelling outriggers 52. In one embodiment, the power unit 44 and arm 22 are situated on the mobile base. In a preferred embodiment, the base is made of finished steel, but of course other suitable materials may be used to construct the base. The base and bogie may be a standard four to eight wheel trailer spine and bogie. In a sample embodiment, the length of the base ranges between about 20 ft and about 24 ft, and the base has a maximum width of about 8.6 ft. Or course, the base may be of other dimensions.

In a sample embodiment, PL has four outriggers that are deployable at approximately 45 degrees from the long axis of the base, such that each outrigger is approximately 90 degrees from adjacent outriggers. In a further sample embodiment, as shown in Figures 1c to 1e, the outriggers may be deployable substantially parallel to the longitudinal axis of the base, a feature which may be helpful if the PL is to be located at a site where space is limited.

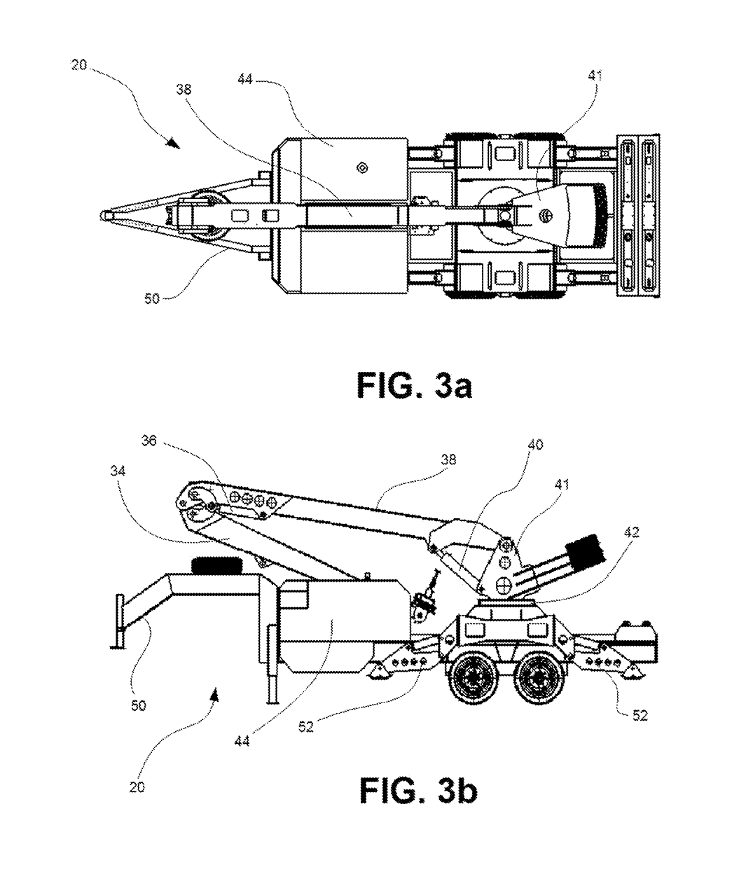

In one embodiment, the PL has two general positions: operation and retracted. In the retracted position, the arm is folded, with boom 38 adjacent to stick 34 such that the arm does not extend beyond the perimeter of base 50, or stays substantially within the perimeter of base 50. For example, as illustrated in FIGS. 3a and 3b, the arm is folded with stick 34 tucked into a slot 43 provided for example in the power unit 44. In the retracted position, the outriggers 52 are retracted and raised away from the ground (i.e. not deployed). The PL may be placed into the retracted position when not in use for ease of storing and/or transporting the PL.

In the operation position, the arm is extended with the vacuum head hanging freely from stick 34. The motion of the vacuum head may be passive or active, as described in detail hereinbelow. Part of the arm, especially the vacuum head, may extend beyond the perimeter of base 50 in the operation position. For example, as illustrated in FIG. 1, the arm is extended with vacuum head 24 beyond the perimeter of base 50. In the operation position, the outriggers 52 are deployed (i.e. extended) to engage the ground. The PL is placed into the operation position during standby (i.e. idling) and/or when in use.

The outriggers may be deployed using the outrigger hydraulic actuators, which may be levelling hydraulic cylinders. Of course, the number of outriggers, the angles of deployment, and the method of deployment may vary depending on the ground configuration on site. In one embodiment, the outriggers are deployed by manually operating the hydraulic cylinders in order to obtain a level operating plane for the PL. In another embodiment the outriggers are deployed automatically and the pressure and level of the base is automatically controlled by the PLC.

Once the PL is towed by the trailer using a tow vehicle to a desired location, the trailer jacks are deployed and the tow vehicle is uncoupled from the trailer. The outriggers are then hydraulically deployed to a position where substantially all load is removed from the wheels and trailer jacks. The outriggers may be further manipulated to level the system if necessary. The PL system may operate independently off of the onboard power unit.

Once the PL is levelled, the outriggers hold pressure and are locked in position during operation of the PL. All hydraulic joints controlling the arm motion can be activated subsequent to the locking of the outriggers, and the arm can move to an idle position, wherein the arm may be retracted such that the vacuum head (or the wrist joint, if the vacuum head is not attached) is close to turret 41 and slew drive 42 to avoid interference with surrounding equipment.

In one embodiment, from the idle position, the arm can move to any position within the reach zones SZ and CZ shown in FIG. 4. Reach zone SZ represents the zone within which the vacuum head can reach safely with minimal risk of interfering with the PL itself. Reach zone CZ represents the zone within which the vacuum head can reach but with some risk of interfering with the PL itself. In the illustrated embodiment, Zone DZ represents the zone within which the vacuum head is not permitted.

When the vacuum head is moved to a desired load position (i.e. when the vacuum head makes contact with a pipe to be picked up), the vacuum pump is turned on, or if it is already on, the vacuum valve is opened, either by manual or automatic control, to engage a portion of the pipe.

For example, in one embodiment, the PL has a deployed base width ranging between about 8.6 ft and about 14 ft, and a deployed base length ranging between about 20 ft and 24 ft. In a sample embodiment, the PL has a maximum reach zone of about 30 ft (see FIG. 4a). In a further sample embodiment, the PL has a working radius of about 28 ft (see FIG. 4a). Of course, the PL may have configurations, dimensions, and reach zones other than those mentioned above.

For example, the PL may be configured to handle a maximum end load of 1500 lbs and a nominal operating load of 550 lbs. In one embodiment, the arm of the PL has six degrees of freedom, four of which can be actively controlled and two of which being passive. In another embodiment, five of the six degrees of freedom can be actively controlled and the remaining one is passive. The arm and its control system are described in more detail hereinbelow.

In a preferred embodiment, the base structure for the arm is placed on the base 50 such that the base structure is centered over the wheels of the mobile base, which may assist in reducing transport load on the hitch.

In a preferred embodiment, the arm of the PL has four joints that can be actively controlled by the control system of the PL: (i) turret and slew drive; (ii) shoulder joint; (iii) elbow joint; and (iv) rotor stator joint.

The turret and slew drive form the lowermost section of the arm and is attached to the base structure. In one embodiment, the turret and slew drive are hydraulically driven to allow the arm to rotate more than 360 degrees about an axis substantially orthogonal to the plane of the base.

In a further embodiment, the shoulder joint is a hydraulic actuator that moves the boom, which is pivotally attached at a lower end to the turret and slew drive, in the range of 0 to about 90 degrees relative to the horizontal plane. For example, the shoulder joint may be actuated by a hydraulic cylinder with a linear transducer or rotary sensor mounted to the joint itself.

An upper end of the boom is pivotally connected to a lower end of the stick (forearm). In a still further embodiment, the elbow joint is a hydraulic actuator that moves the stick within a range of 0 to about 120 degrees relative to the long axis of the boom. The elbow join actuator may be actuated by a hydraulic cylinder with a linear transducer or rotary sensor mounted to the joint itself.

An upper end of the stick is connected to an upper wrist, which in turn is connected to the rotor stator joint. In another embodiment, the wrist can be actuated with respect to the stick with a linear actuator (not shown) for further control. In a still further embodiment, the rotor stator joint is a rotor with preferably greater than 360 degrees of rotation about the central axis of the upper wrist. The rotor stator is connected to a lower wrist, which in turn is connected to the vacuum head. The rotor stator joint can be used to rotate a pipe that is engaged by the vacuum head, on a horizontal plane about the central axis of the upper wrist.

The arm, vacuum head and vacuum system are designed to allow pipes that are not necessarily in the horizontal position (i.e. the long axis of the pipe is substantially orthogonal to the direction of the force of gravity) to be picked up and transported. The arm, vacuum head and vacuum system may also be configured to allow pipes to be dropped off in positions other than the horizontal position. This may be accomplished passively or actively. FIGS. 1b and 1e show a sample embodiment where the vacuum head is positioned at an angle relative to the horizontal.

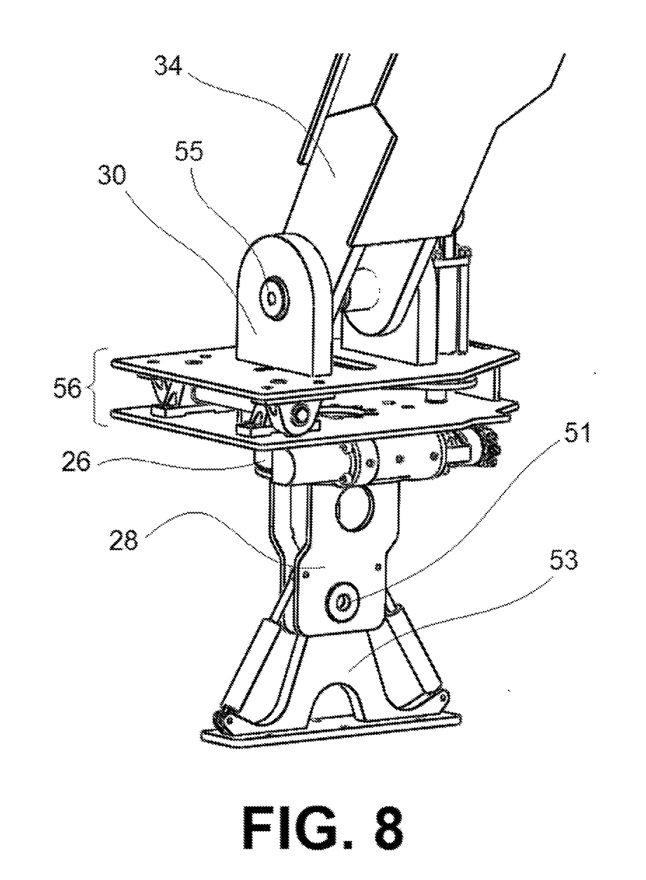

In one embodiment, the vacuum head and the rotor stator joint are connected via the lower wrist by a lower wrist joint that allows the vacuum head to dangle freely and passively, with the face of the vacuum head substantially parallel to the horizontal plane, while the vacuum head is not engaging a pipe. For example, with reference to FIG. 8, the vacuum head may be connected to the lower wrist 28 by an end effector mount 53 via a lower wrist joint 51. The upper wrist 30 is connected to the stick 34 by an upper wrist joint 55. The vacuum head is not shown in FIG. 8. Preferably, the vacuum head or another end effector is releasably couple-able to the end effector mount. The lower wrist joint is shown as a pinned joint in FIG. 8 but, of course, other types of joints may be used to connect the end effector mount, and the vacuum head when connected to the end effector mount, to the rotor stator joint to provide the end effector mount and the vacuum head the freedom to tilt relative to the horizontal plane.

Alternatively or additionally, the angle of the vacuum head face relative to the horizontal plane may be actively driven and controlled by the control system.

In one embodiment, the arm of the PL includes two joints that are passive: (i) the upper wrist joint 55 and (ii) the lower wrist joint 51. The upper wrist joint is a vertically hanging pin joint that ensures that the rotor stator is always loaded axially. In one embodiment, the vacuum head is mounted to the end effector mount by bolts. In this embodiment, the lower wrist joint may be a passive pin joint that allows the vacuum head to make contact with a pipe whose long axis is not necessarily in a horizontal position, to carry a pipe off-center such that the pipe is not necessarily in a horizontal position while in transit, and/or to place a pipe at angles relative to the horizontal. Off-center means that the center of gravity of the pipe is not aligned with the long central axis of the lower wrist joint.

In another embodiment, one or both of the upper wrist joint and the lower wrist joint are actively controllable, such that the angle of the vacuum head face is actively adjustable.

In a sample embodiment, the angle of the vacuum head face relative to the horizontal may range between about 0° to about 90°, whether the vacuum head is passive or actively-controlled.

In the passive mode, contact with the pipe, or contact of the pipe with external structures such as the V-door may provide a moment sufficient to pivot the vacuum head to a conforming inclination. In the active mode, the vacuum head can be motor driven to a specific inclination.

The vacuum head may include resistive springs or bearings that act as dampers during angled (or off-horizontal) pipe placement. The resistive springs or bearings may further help compensate for any see-sawing motion when hoisting a pipe off-center and/or from one of its ends. A device may be included in the PL to accommodate the shear forces necessary to securely hold a pipe at an angle relative to the horizontal plane.

In another example, the PL includes a mechanical stop that prevents the vacuum head from rotating about the axis of the lower wrist in one selectable direction. To engage the mechanical stop, a pipe is intentionally picked up slightly off-centred. This allows the pipe to remain stable in motion. The mechanical stop is configured to prevent rotation in a first direction, so that the pipe can only be rotated in a second direction opposite to the first direction when it comes into contact with the v-door or when the vacuum head picks up a pipe at the v-door. In one embodiment, the mechanical stop is adjustable to allow either rotation direction to be restrained at a given time, depending on the relative locations of the PL and the rig on site.

In one embodiment, the turret, boom, stick and upper and lower wrists are constructed of plate steel; however, other suitable materials may be used to construct the components of the arm.

In a further embodiment, one or both of the slew drive and the rotor stator may include encoders for position measurement and control.

In a sample embodiment, the slew drive has a maximum rotational velocity of about 4 RPM and the rotor stator has a maximum rotational velocity of about 4 RPM. Of course, other speeds are possible.

In a further embodiment, the PL has more than the minimal number of actuators by including a linear actuator (not shown) in-line with the vacuum head. In other words, the PL is configured such that the arm can complete the same motion in more than one way (i.e. using different actuators), thereby providing redundancy. In one embodiment, the linear actuator allows the vacuum head to extend outwardly without much movement of the arm. When the PL has positioned a pipe in line with the previous pipe in the drilling rig mast, the linear actuator allows the PL to stab into the receiving pipe or joint, while preventing extraneous movement of the pipe arm. This embodiment may be beneficial for use in the confined space of a drilling rig mast, since it may be undesirable for the arm to perform certain movements given its proximity to other site equipment. By mounting the vaccum head to the linear actuator, the motion required to stab a pipe can be performed by the PL without or with minimal movement of the actuators in the arm.

The suction power of the vacuum head is provided by the vacuum pump, valves and control system in the power unit located on mobile base. In one embodiment, the vacuum pump is directly driven by the power unit on the mobile base. The vacuum pump may be manually controlled with an “on-off” switch with safety lockouts. The suction line between the vacuum pump and vacuum head, which run along the length of the arm, may include check valves to help ensure suction lock in case of line break. In a preferred embodiment, the end of the suction line at the vacuum head is substantially centered on the face of the vacuum head.

In a sample embodiment, the vacuum head (and suction system) is configured to handle pipes with diameters between 2¾″ and 7½″. Of course, the vacuum head (and suction system) can be configured to handle pipes of other sizes.

The PL allows manual and automated control of most of its functions. In one embodiment, the outriggers and the levelling of same can be activated and controlled manually and remotely by an operator. In a further embodiment, the operator can control the movement of the arm, for example through an automated PLC included in the control system of the PL. For safety reasons, the motion of arm may require operator supervision at all times. As such, the PL may be configured to allow movement of the arm only when the operator depresses and holds a button throughout the operation of the arm (i.e. a deadman switch). In one embodiment, the suction of the vacuum head is activated and/or deactivated manually by the operator.

In a further embodiment, the PLC controller includes a learn function to allow for automation of arm movement sequences. For example, when the PL is first set up at the rig, the operator activates the learn function of the PLC and moves the end effector, via movement of the arm, through a calibration pattern starting at a V-door position and inclination (a “start position”) to a pipe rack position and inclination (an “end position”). This pattern can then be learned and repeated by the PLC, while it can also compensate for disturbances. Other obstacles can be identified as keep-out areas during the learn function calibration phase.

The PLC is a component in the control system for the PL. The PLC is a processor. The PLC polls data from system sensors which is used in automation and control of the PL. The types of sensors that can be polled by the PLC include, for example, linear and rotary position sensors, pressure transducers, temperature sensors, inclination (tip) sensors, cameras, contact sensors, proximity sensors, global positioning system, vibration sensors, and rangefinders. The PL may include one or more of these sensors and may include a combination of different types of sensors. Not all of the sensors mentioned above are required for the functioning of the PLC.

In a sample embodiment, a rotary position sensor is installed on one or more joints in the arm (e.g. boom-turret joint, shoulder joint, etc.). In another sample embodiment, a pressure transducer is installed on the PL for monitoring hydraulic pressure provided by the hydraulic system. A temperature sensor may be included to monitor hydraulic fluid temperature, power unit temperature, control system temperature, etc. In a further embodiment, an inclination sensor is installed in the base near the turret to monitor the levelness of the PL relative to the ground surface, or to a plane substantially perpendicular to the vertical as determined by gravity, so that the outriggers may be adjusted if necessary. With reference to FIG. 8, a contact sensor, which may be for example a pressure transducer, may be included in a load sensing assembly 56 for measuring load. In another embodiment, a global positioning system may be included in the control system for communication location of the PL to the PLC.

In one embodiment, the PLC includes a graphical user interface and/or a human-machine interface (“HMI”), through which a user can operate and control the PL. Alternatively or additionally, the PLC is wire or wirelessly linked to a user remote control through which the PL can be operated and controlled.

The control system of the PL may further include a radio remote control which provides a button or similar human-machine interface for a user to communicate with the PLC. In one embodiment, the radio remote is selected to be certified for operation in hazardous areas (i.e. explosion proof), and includes control paddles for controlling movement of the arm via the PLC. The remote control may include other controls, such as arm speed and position selection. The remote control may include a plurality of indicators (e.g. LEDs) for indicating, for example, arm status, vacuum status, base level status, and system status to the user. In a further embodiment, the remote control has an indicator (e.g. a buzzer) to signal any PLC and/or remote control defect and/or malfunction. The control system may include a safety function, where PLC locks the arm and/or stops the PL motor if, for example, the PLC detects a loss of communication with the remote control and/or a lack of battery power in the remote control.

In a further embodiment, the load on the arm may be monitored by, for example, the load sensing assembly, and the PLC may automatically slow down the arm movement if the load on the arm approaches the weight limit of the arm. The vacuum pressure may also be monitored by the PLC. For example, if the vacuum pressure is below a certain preselected level, the PLC triggers an alarm to alert the user. The PLC may also monitor the hydraulic pressure on the outriggers to ensure that an acceptable weight distribution is maintained on the outriggers. For example, if the pressure on one outrigger drops unexpectedly, the PLC continues to operate the arm and may optionally sound an alarm to alert the user. Further, if a second outrigger loses pressure unexpectedly, the PLC sounds an alarm to alert the user that the PL may be approaching an unsafe tipping point.

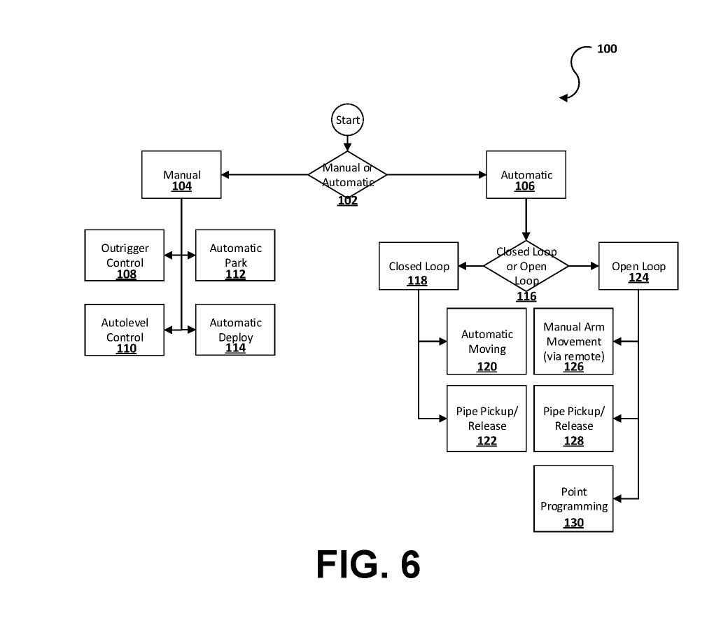

FIG. 6 shows a sample process flow chart of the PLC during operation. The control of the process flow during operation can be managed through the onboard graphical user interface, HMI and/or the user remote control. In one embodiment, the PL status as well as location and run time can be transmitted via a data transmission interface to an internet storage server, or other storage media, where the data can be remotely accessed by authorized personnel. The data transmission interface may include, for example, cellular technology, satellite technology, and wireless communication networks (e.g. WiMax, WiFi, Bluetooth, Zigbee, or the like). The same data transmission interface may be used for remote programming and diagnostic of the PLC.

In a sample embodiment, the PLC process 100 starts by receiving an input for a manual process or an automatic process (step 102). If an input for a manual process is received (step 104), the PLC accepts commands for one or more of: outrigger control (step 108), auto-level control (step 110), automatic park (step 112), and automatic deploy (step 114).

In the outrigger control mode (step 108), the PLC accepts user input commands via the HMI or remote control for controlling the extension and retraction of the outriggers. For the auto-level control (step 110), the PLC receives and processes dual axis level data from the inclination sensor to determine the current spatial tilt of the PL. Once the tilt is determined, the PLC modifies the outriggers to achieve a spatial tilt of less than about +/−0.5° in each axis (with respect to the ground level or a horizontal plane relative to gravity). The level algorithm of PLC also monitors outrigger pressure to ensure that each outrigger is carrying a minimal amount of PL weight after the level operation is complete. In the automatic park mode (step 112), the PLC automatically retracts the arm and the outriggers, for example as shown in FIG. 3, which may assist with storage and/or travel of the PL. In the automatic deploy process (step 114), the PLC automatically deploys the outriggers and moves the arm into the operation position where an end effector can be installed to the arm, if not installed already, and the arm is ready for operation.

If the PLC receives an input for an automatic process by, for example, the user selecting “automatic mode” via the HMI or remote control (step 106), the PLC prompts the user to select a closed loop or open loop operation (step 116).

If the PLC receives an input for an open loop operation (step 124), the PLC accepts user input commands from the remote control, whether in wire or wireless communication with the PLC, to control the movement of the arm and the end effector (step 126). Based on the user input commands, the PLC moves the arm via the actuators of the slew drive, boom, stick, and wrist.

In a preferred embodiment, the motion of the arm and the end effector is spatially limited in order to protect the PL itself. This may include limitations on the degrees of motion of the slew drive to prevent pipe damage to the motor and control panel. The wrist motion may also be limited based on stick and boom position in order to prevent pipe damage to the arm.

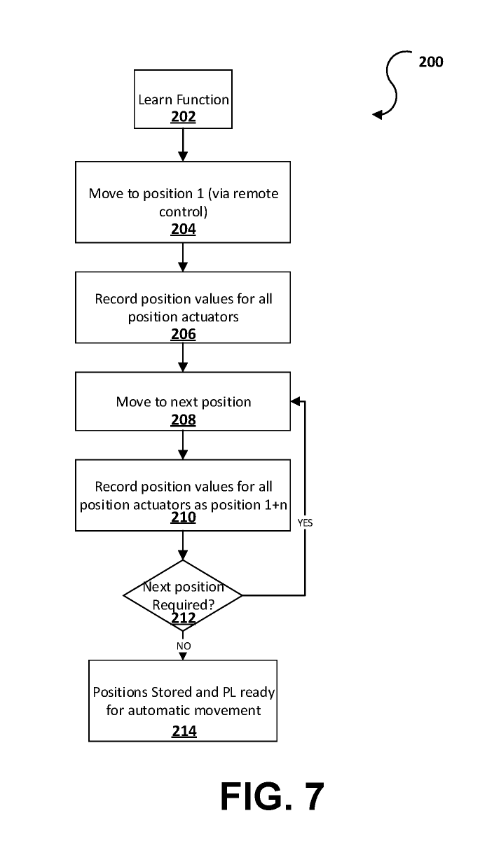

The PLC also accepts commands from the remote control for picking up and/or releasing pipe (step 128). In open loop operation, the end effector is positioned in contact with the pipe for pickup and drop-off. In the open loop mode, the points of travel of the end effector may programmed by the user in the point programming process (step 130), which is described in more detail hereinbelow with reference to FIG. 7. For example, upon user command, the PLC saves the current position of the end effector for future automated playback (step 120).

If the PLC receives an input for a closed loop operation (step 118) and for automatic moving (step 120), and provided that the point programming process (step 130 and as described below) has been completed, the PLC automatically moves the end effector to a pre-recorded position in accordance with the user input received by the PLC.

Once the PLC moves the end effector to the user-selected position, the PLC receives either a pipe pickup or release command from the user via the HMI or remote control. If the input is pipe pickup (step 122), the PLC lowers the vacuum head automatically until it detects contact of the face of the vacuum head with the pipe, and then powers the vacuum system to provide suction to the vacuum head to engage the pipe. The PLC monitors the load on the vacuum head and/or the vacuum suction pressure to determine whether the pipe has been successfully picked up by the vacuum head. Once the pipe is picked up by the vacuum head, the PLC can receive a user input request that the pipe be moved automatically in accordance with a pre-recorded playback sequence (step 120).

If the input is pipe drop-off (step 122), the PLC lowers the vacuum head automatically until it detects that the pipe has contacted the ground (or another surface), and then powers off the vacuum system to cease suction on the pipe to release same. Once the pipe is released, the PLC can receive a user input request that the end effector be moved automatically in accordance with a pre-recorded playback sequence (step 120).

FIG. 7 illustrates a sample process flow 200 for point programming the PL (also referred to herein as the “learn function”). Upon receiving a user input command for point programming, the PLC is triggered into starting the learn function (step 202). The PLC then detects movement of the arm and a selection of a first position of the end effector by the remote control (step 204). For example, the first position may be at the location where pipes are stored (i.e. where the pipes are to be picked up). The word “position” with respect to point programming and learn function of the PL, includes the angle of the end effector, if applicable (i.e. if the end effector is picking up or dropping off a pipe at an angle relative to the horizontal). Upon detecting the first position, the PLC records the position of all the actuators of the arm for the first position (step 206). The PLC then detects movement of the arm away from the first position and a selection of a second position (step 208). The second position may be a point in an interim path between where the location where the pipes are to be picked up (i.e. the start position) and the location where the pipes are to be dropped off (i.e. the end position). Alternatively, the second position may be the end position. Upon detecting the second position, the PLC records the position of all the actuators of the arm for the second position (step 210).

Alternatively or additionally, the PLC may automatically record any position (and arm actuators positions) at any point along the interim path without prompting by the user. Any interim position recording (whether user-prompted or automatically recorded by the PLC) can be subsequently changed by the user, for example, if the user decides that adjustments are required after a number of movement sequences have been completed.

After a second position is recorded, the PLC may receive a command to record another position (step 212) and then it detects movement of the arm and a selection of a third position (step 208). Upon detecting the third position, the PLC records the position of all the actuators of the arm for the third position (step 210). Steps 208 and 210 may be repeated as many times as the PLC is prompted to record a position.

Once the last position is recorded (i.e. if no additional position recording is required (step 212)), the PLC is ready to move the PL automatically in accordance with the recorded positions, and corresponding end effector angles, if applicable (step 214), collectively forming a “playback” sequence. Preferably, all position data are stored in non-volatile PLC memory or may be stored and/or backed up remotely.

In another embodiment, the PL can calculate an optimal path between two positions and use sensors to ensure the safety of the optimal path and adjust the path as required.

Other embodiments include a single pick-up location to single drop-off location (e.g. service rig, slant rig, conventional drilling rig), a single pick-up location to multiple drop-off locations (e.g. pipe deck to cantilever deck for an off-shore drilling rig, hole centre to setback), multiple pick-up locations to a single drop-off location (e.g. cantilever deck to the pipe deck for an off-shore drilling rig, setback to hole centre), and multiple pick-up locations to multiple drop-off locations (e.g. setback to mouse hole or hole centre).

The playback function of the PL is initiated by placing the PL into the closed loop mode (FIG. 6, step 118). While moving through the playback sequence, the PLC can proceed in either piecewise linear movement across all recorded positions or, in an alternative embodiment, the PLC can calculate a trajectory using curve fitting algorithms common to motion controllers. Each recorded position is reached by the arm through precise motion control of the hydraulic system using automatic networked valves connected to the PLC. The control methods used by the PLC are proportional, proportional-integral, or proportional-integral-derivative.

In one embodiment, the end effector may be directed to any of the recorded positions by the PLC upon receiving a command from the remote control. For example, when the operator selects a position (e.g. the start position, the end position, or any recorded position therebetween) via the remote control, the PLC starts the arm movement sequence to automatically move the end effector to the selected position.

In a further embodiment, the end effector may be directed to any position by the PLC upon receiving a command from the remote control. For example, the user may select a position using GPS via the remote control to signal the PLC record that position and/or to move the end effector to that position. A position may also be indicated to the PLC by physical visual markers. For example, each pipe may include a coloured symbol somewhere on its outer surface that is recognizable by the PLC, in order for the PLC to direct the end effector thereto. In a still further embodiment, the remote control includes a plurality of touch screens and the user may select and/or record a position by touching the touch screens, wherein the plurality of touch screens allows the PLC to triangulate exact three-dimensional location of the selected position.

The PL may have one or more of the above-described methods for allowing a user to select a position for the PLC to move the end effector and/or record the position of the end effector.

The operator can also manually manipulate the arm to either pick up a pipe or position a pipe anywhere within the reach zones, which may be necessary for manoeuvring pipes for safety reasons, for moving the end effector at a greater precision than the automated arm playback sequences, and/or for positioning adjustments for recalibration of the playback sequences.

The previous description of the disclosed embodiments is provided to enable any person skilled in the art to make or use the present invention. Various modifications to those embodiments will be readily apparent to those skilled in the art, and the generic principles defined herein may be applied to other embodiments without departing from the spirit or scope of the invention. Thus, the present invention is not intended to be limited to the embodiments shown herein, but is to be accorded the full scope consistent with the claims, wherein reference to an element in the singular, such as by use of the article “a” or “an” is not intended to mean “one and only one” unless specifically so stated, but rather “one or more”. All structural and functional equivalents to the elements of the various embodiments described throughout the disclosure that are known or later come to be known to those of ordinary skill in the art are intended to be encompassed by the elements of the claims. Moreover, nothing disclosed herein is intended to be dedicated to the public regardless of whether such disclosure is explicitly recited in the claims. No claim element is to be construed under the provisions of 35 USC 112, sixth paragraph, unless the element is expressly recited using the phrase “means for” or “step for”.

1. A method for automating the pickup and drop-off of a pipe from a first location to a second location, respectively, using a robotic arm having actuators and an end effector, the robotic arm being controlled by and in communication with a processor, and the method being carried out by the processor, the method comprising:
receiving a user input command to start a point programming process;
detecting a selection of a first position of the end effector;
recording the position of the actuators for the first position;
detecting a selection of a second position of the end effector;
recording the position of the actuators for the second position; and
(i) detecting a selection of one or more user-selected interim positions, each user-selected interim position being between the first position and the second position, and recording the position of the actuators for the one or more user-selected interim positions; or
(ii) automatically recording the position of the actuators for one or more detected interim positions, each detected interim position being between the first position and the second position, without detecting a selection of the one or more detected interim position.

2. The method of claim 1, wherein the first position is the first location and/or the second position is the second location.

3. The method of claim 1, wherein the robotic arm engages the pipe at the end effector by suction, and the method further comprises sensing a load on the robotic arm and: (i) adjusting the suction according to the load and/or (ii) adjusting a movement speed of the robotic arm according to the load.

4. The method of claim 1, further comprising receiving a user input command to modify the recorded position of the actuators for one or more of: the first position, the second position, one of the one or more user-selected interim positions, and one of the one or more interim positions.

5. The method of claim 1, further comprising calculating an optimal path between (i) the first position and the second position; (ii) the first position and one of the one or more user selected interim positions; (iii) one of the one or more user-seleeted interim positions and the second position; and/or (iv) two of the one or more user-selected interim positions.

6. The method of claim 4, further comprising (i) receiving signals from one or more sensors, the one or more sensors for detecting obstacles and/or other pad constraints, and (ii) adjusting the optimal path based on the received signals.

7. The method of claim 5, wherein the optimal path is calculated to accommodate constrained spaces, equipment obstacles, worker safety zones, and/or other pad constraints.

8. The method of claim 1, further comprising receiving a user input command to move the end effector to a selected position, the selected position being the first position, the second position, or a new position; and moving the end effector to the selected position.

9. The method of claim 8, further comprising receiving a user input command to pick up the pipe; and picking up the pipe with the end effector.

10. The method of claim 8., further comprising receiving a user input command to release the pipe; and releasing the pipe from the end effector.

11. The method of claim 1, wherein the selection of the first position or the second position is achieved by a physical visual marker.

12. The method of claim 1, wherein: (i) the first location is a pipe rack or tub, and the second location is a rig V-door, or vice-versa; or (ii) the first location is a pad and the second location is a rig floor, or vice-versa; or (iii) the first location is behind samson posts and the second location is a mouse hole or hole centre, or vice-versa; or (iv) the first location is the mouse hole and the second location is a set-back, or vice versa.

13. The method of claim 1, wherein the robotic arm is supported by a base having a plurality of deployable and retractable levelling outriggers, and the method further comprises deploying the outriggers to engage a ground surface or retracting the outriggers to disengage from the ground surface.

14. The method of claim 1, further comprising moving the robotic arm along a travel path between the first position and the second position, wherein the travel path is determined based on the recorded position of the actuators for the first position, the recorded position of the actuators for the second position, and the automatically recorded position of the actuators for the one or more detected interim positions.

15. A pipe loader for loading and/or unloading one or more pipes, the pipe loader comprising:
a base;
an arm having a first end connected to the base and a second end;
a rotor stator joint pivotably connected to the second end of the arm;
an end effector releasably and pivotably connectable to the rotor stator joint via a lower wrist joint, the rotor stator joint allowing the end effector to rotate about an axis and the lower wrist joint allowing the end effector to passively and/or actively tilt relative to a horizon plane;
a power unit positioned on the base for supplying power to the arm;
a control system for controlling movement of the arm and the end effector; and
a vacuum pump positioned on the base for supplying suction to the end effector, and the control system controls the vacuum pump.

16. A pipe loader for loading and/or unloading one or more pipes, the pipe loader comprising:
a base;
an arm having a first end connected to the base and a second end;
a rotor stator joint pivotably connected to the second end of the arm;
an end effector releasably and pivotably connectable to the rotor stator joint via a lower wrist joint, the rotor stator joint allowing the end effector to rotate about an axis and the lower wrist joint allowing the end effector to passively and/or actively tilt relative to a horizon plane;
a power unit positioned on the base for supplying power to the arm;
a control system for controlling movement of the arm and the end effector; and
a plurality of deployable and retractable levelling outriggers in the base for engaging and disengaging, respectively, a ground surface.

17. A pipe loader for loading and/or unloading one or more pipes, the pipe loader comprising:
a base;
an arm having a first end connected to the base and a second end;
a rotor stator joint pivotably connected to the second end of the arm;
an end effector releasably and pivotably connectable to the rotor stator joint via a lower wrist joint, the rotor stator joint allowing the end effector to rotate about an axis and the lower wrist joint allowing the end effector to passively and/or actively tilt relative to a horizon plane;
a power unit positioned on the base for supplying power to the arm;
a control system for controlling movement of the arm and the end effector, the control system comprising a processor having a self-learning function for recording a travel path of the end effector and automatically playing back the travel path.

18. A pipe loader system comprising at least two robotic arms for loading and unloading a pipe at a service rig, a slant rig, a conventional drilling rig, an off-shore drilling rig, or a pipe storage facility, and being connectable to a power source, a processor, and an end effector, each of the at least two robotic arms comprising:
a boom having a first end and a second end;
a stick having a first end and a second end, the first end being pivotably connected to the second end of the boom;
an upper wrist pivotally connected to the second end of the stick, the upper wrist having
a rotor stator joint connected to the upper wrist, the rotor stator joint being rotatble about the central axis of the upper wrist;
an end effector mount pivotally connected to the rotor stator joint by a lower wrist joint that allows the end effector mount to tilt relative to a horizontal plane at an angle between 0 and about 90 degrees, and the end effector mount is releasably couple-able to the end effector, wherein there is a hand off zone that is reachable by the end effectors of any two of the at least two robotic arms.

19-37. (canceled)
